(19) United States
(12) Patent Application Publication
(10) Pub. No.: US 2011/0188353 A1
(43) Pub. Date: Aug. 4, 2011

(54) ELECTRON BEAM LITHOGRAPHY METHOD, ELECTRON BEAM LITHOGRAPHY APPARATUS, METHOD FOR PRODUCING A MOLD, AND METHOD FOR PRODUCING A MAGNETIC DISK MEDIUM

(75) Inventors: IKUO TAKANO, KANAGAWA-KEN (JP); TOSHIHIRO USA, KANAGAWA-KEN (JP)

(73) Assignee: FUJIFILM CORPORATION, TOYKO (JP)

(21) Appl. No.: 13/017,301

(22) Filed: Jan. 31, 2011

(30) Foreign Application Priority Data
Jan. 29, 2010 (JP) 2010-017553

(51) Int. Cl. G11B 11/00

(52) U.S. Cl. 369/13.24; G9B/11

(57) ABSTRACT

Irradiation of an electron beam onto a base plate having resist coated thereon is controlled by ON/OFF signals output to a blanking element. Beam deflecting operations are controlled by deflecting signals output to a deflecting element. Patterns of servo areas and data areas are scanned and drawn on the base plate over a plurality of rotations. The electron beam is scanned in two directions so as to fill the shapes of patterns in the servo areas during a specific rotation, patterns in the data area are drawn as a continuous line or broken line with a single electron beam emission. The patterns of the data area are not drawn during other rotations, by shielding irradiation of the electron beam.

### BACKGROUND OF THE INVENTION

1. Field of the Invention

The present invention is related to an electron beam lithography method and an electron beam lithography apparatus, for drawing fine patterns corresponding to desired patterns of protrusions and recesses when producing molds, including imprinting molds for high density magnetic recording media, such as discrete track media and bit patterned media.

In addition, the present invention is related to a method for producing molds, including imprinting molds, having patterns of protrusions and recesses on the surfaces thereof, using the electron beam lithography method. Further, the present invention is related to a method for producing magnetic disk media, onto which patterns of protrusions and recesses are transferred using the molds.

2. Description of the Related Art

There is demand for increase in recording density in magnetic disk media. Discrete track media (hereinafter, also referred to as “DTM”) and bit patterned media (hereinafter, also referred to as “BPM”) are being focused on. The hard disk patterns of DTM are constituted by servo patterns, which are formed in servo areas for controlling tracking, and data groove patterns, which are formed in data areas (recording regions). The data groove patterns are formed as grooves (lines) that separate adjacent data tracks recording media, to reduce magnetic interference among adjacent tracks and to increase recording density. Meanwhile, the hard disk patterns of BPM are constituted by servo patterns, which are formed in servo areas for controlling tracking, and data bit patterns, which are formed in data areas (recording regions). In the data bit patterns, magnetic materials (single domain magnetic particles) that constitute a single domain are physically isolated and arranged in a regular dot pattern. One bit of data is recorded in each single domain magnetic particle.

Conventionally, fine patterns such as the aforementioned servo patterns are formed as patterns of protrusions and recesses on magnetic disk media. The electron beam lithography method has been proposed as a method for patterning predetermined fine patterns onto base plates of imprinting molds for producing high density magnetic disk media. The electron beam lithography method draws patterns by irradiating an electron beam corresponding to the shape of a pattern onto a base plate coated with resist while rotating the base plate. Two lithography methods have been proposed as methods for drawing servo patterns and data groove patterns simultaneously with respect to DTM (refer to U.S. Patent Application Publication Nos. 20090123870 and 20050151284, for example).

The electron beam lithography method disclosed in U.S. Patent Application Publication No. 20090123870 (hereinafter, referred to as “high speed modulating scan method”) draws servo patterns and data groove patterns for a single track within each rotation of a base plate. As illustrated in FIG. 9A, servo elements 113 are rectangles that extend in the width directions of tracks. Therefore, servo patterns are drawn by finely modulating an electron beam at high speed in the circumferential direction and deflecting the electron beam in the radial direction to fill the shapes of the servo elements 113 one by one. Meanwhile, data groove patterns 116 are arcuate lines that extend in the circumferential directions of tracks. Therefore, the data groove patterns 116 are drawn by rotating the base plate in a single direction while fixing the radial position of the electron beam at a drawing position to draw the data groove patterns 116 in an arcuate manner and deflecting the electron beam (EB deflection) in the circumferential direction to change the scanning speed, to draw the data groove patterns 116 at a predetermined width in a spliced manner. At this time, if the linear rotation speed of the base plate is set to values suited for high speed modulating lithography of the servo elements 113, and the data groove patterns 116 are drawn by continuous fixed irradiation of the electron beam that depends only on the rotation of the base plate, the irradiation dosage will be excessive, because the areas to be drawn for the servo patterns and the data groove patterns are different. This leads to line widths to become greater than desired dimensions. Therefore, the electron beam is deflected in the circumferential direction along with rotation of the base plate to perform scanning having an optimal amount of exposure, to obtain desired line widths.

The electron beam lithography method disclosed in U.S. Patent Application Publication No. 20050151284 (hereinafter, referred to as the “multi pass method”) draws each single track divided into N. As illustrated in FIG. 9B, the irradiation of an electron beam is controlled ON and OFF, to draw a servo element 213 and 1/N the width of a data groove pattern 216 during a single rotation of the base plate. The beam irradiating position is moved for a single division in the radial direction, to draw the next 1/N widths of the servo element 213 and the data groove pattern 216 during a subsequent rotation. The servo element 213 and the data groove pattern 216 for a single track is drawn over N rotations of the base plate. The data groove patterns 216 are formed to have widths of approximately ½ a track width or less. Therefore, the electron beam is irradiated in the data areas for M rotations during drawing of a single track, to draw the data groove pattern 216 in an overlapping manner and to obtain an optimal amount of exposure. During the remaining N-M rotation, the irradiation of the electron beam is shielded, to draw the data groove pattern 216 having a desired line width.

The recording densities of magnetic disk media such as hard disks are increasing yearly. Particularly, highly fine and highly accurate patterns are desired for patterns corresponding to the servo patterns formed in servo areas and data groove patterns or data bit patterns to be formed in data areas of the aforementioned DTM and BPM. In these media, it is necessary to suppress dimensional workability to several tens of nm or less and line width roughness (hereinafter, referred to as “LWR”) to a level of several nm. In addition, arrangement accuracy on the order of several net is also necessary.

Among the aforementioned patterns, the data groove patterns and the data bit patterns affect magnetic recording performance. Not only do the data groove patterns and the data bit patterns have the minimum work dimensions in DIM (BPM), but they also require LWR on the order of several nm. It is difficult to achieve these dimensional levels using the lithography technique due to resolution problems, and realization of low LWR is positioned as an extremely difficult objective (reference documents: “A study of the track edge fluctuation for discrete track media”, M. Hashimoto et al.,

Collection of Abstracts from the 30th Conference of the Japan Applied Magnetics Academy, p. 336, 2006; and “Design of Ni Mold for Discrete Track Media”, K. Ichikawa et al., IEEE Transactions on Magnetics, Vol. 44, Issue 11, pp. 3450-3453, 2008).

However, in the high speed modulating scan method of U.S. Patent Application Publication No. 20090123870, it is necessary to draw the data groove patterns or the data bit patterns using complex electron beam deflection and scanning synchronized with the rotation of the base plate. Therefore, it is difficult to secure control accuracy, and beam scanning accuracy is insufficient. Accordingly, LWR deteriorates when drawing data groove patterns, and fluctuations in bit size increase when drawing data bit patterns. That is, the data group patterns are formed as an arcuate line shape by splicing sections together. Thereby, drawing position shifts (steps) occur due to insufficient accuracy at the splice connection portions, and variations in line widths occur due to excessive or insufficient beam irradiation levels caused by temporal shifts in the drawing initiating and drawing ceasing positions. These are factors that cause protrusions and recesses to be generated in the shape of the continuous arcuate line, to deteriorate LWR. During drawing of data bit patterns, relative linear velocity is increased by electron beam deflection and the electron beam is intermittently irradiated by ON/OFF control at short temporal intervals, and it is difficult to secure uniform drawing times at uniform intervals. Accordingly, variations in bit sizes occur due to fluctuations in beam irradiation levels and fluctuations in drawing distances corresponding to irradiation times. Servo patterns are drawn during specific rotations of the base plate. Therefore, drawing of the servo patterns is greatly influenced by errors in the rotation of the base plate and errors in irradiation control of the electron beam during the specific rotations. In the case that various errors are compounded, the accuracy of positions at which the servo patterns are formed (pitch accuracy) deteriorates.

In the multi pass method disclosed in U.S. Patent Application Publication Nos. 20050151284, electron beam latent images become blurred due to overlapped drawing at each rotation of the base plate, resulting in a problem that LWR deteriorates. That is, during stage rotation of lithography apparatuses, the irradiation positions of electron beams fluctuate by several nm due to modulations of rotational axes, and due to fluctuations in external electric/magnetic fields. In the multi pass method in which the data groove patterns are drawn over a plurality of rotations, the accumulation of the beam irradiation position fluctuations result in the contrast of the electron beam latent images decreasing. This leads to non uniformities during development, and as a result, the LWR, which is a measure of pattern quality, deteriorates.

As described above, it is difficult for conventional lithography methods to secure LWR of the data groove patterns. In addition, the fluctuations in bit sizes of data bit patterns become large. In fine patterns which are actually drawn using these conventional lithography methods phenomena, such as data groove patterns of adjacent tracks being connected, a single data groove pattern being cut off, the gaps among bits of data bit patterns becoming irregular and disrupting bit arrangements, occur. That is, there is difficulty in forming regular patterns.

In addition, the formation accuracy of servo patterns influences tracking performance in positioning magnetic heads, and arrangement accuracy on the order of several on is desired. However, sufficient arrangement accuracy cannot be secured for servo patterns by the conventional lithography methods, due to errors in electron beam irradiation positions (positional shifts) caused by errors in rotational driving of base plates, and timing errors in ON/OFF control of beam irradiation. As a result, there is a problem that tracking performance corresponding to recording density cannot be maintained.

As a characteristic of electron beam lithography apparatuses, it is difficult from the view of apparatus function to finely adjust beam irradiation levels (beam current) and base plate linear velocity at least during a single rotation of base plates. Therefore, it is not possible to control and adjust dose amounts according to the shapes of patterns by changing the beam irradiation dosage and the rotational speed of the base plate, to secure drawing accuracy. The beam irradiation dosage and the linear velocity of the base plate are set to constant values as a precondition of electron beam lithography. In addition, it is necessary to maintain a constant dose amount to achieve a predetermined exposure state with respect to the sensitivity of resist which is coated on the base plates.

Meanwhile, performing pattern lithography for a single track within a single rotation as disclosed in U.S. Patent Application Publication No. 20090123870 in order to improve the drawing accuracy in the case that one track width is divided to perform pattern lithography for a single track over a plurality of rotations as disclosed in U.S. Patent Application Publication No. 20050151284 is being considered. However, in this case, the areas to be drawn for the servo areas and the data areas are great at the servo areas and small at the data areas. Therefore, it is necessary to set the scanning speed of a beam spot, that is, the relative linear velocity between the movement speed of the base plate and the beam deflection speed, to be constant, for the dose amount of electron beam lithography at each of these regions to be constant. However, achieving such settings is difficult.

For example, consider a case that the irradiation properties of the electron beam are set such that a predetermined dose amount is obtained at a drawing speed according to the rotational linear velocity of the base plate for data groove patterns of data areas that extend in the circumferential direction of tracks, or for data bit patterns. In this case, if the servo patterns are to be drawn by scanning the electron beam so as to fill the shapes thereof, there is insufficient time at the rotational linear velocity suited for drawing the data areas to scan the servo patterns, and it is necessary to set the rotational linear velocity of the base plate to a lower speed. Conversely, if the aforementioned settings are set to be suited for drawing the servo areas, such settings are not suited for drawing the data areas. That is, the irradiation dosage of the electron beam will be excessive, the dose amount will be too high, exposure seepage will result in line widths becoming too great, and a problem arises that drawing at a predetermined width with respect to a track width cannot be performed.

In the case of the multi pass method, in which each track is divided, and a single divided portion is drawn during each rotation by ON/OFF control, accompanying the increase in the number of tracks due to the miniaturization of patterns to be drawn, there is a problem that a great amount of time is required to draw the entire surface of a single disk. In this case, reduction of drawing time becomes an objective.

### SUMMARY OF THE INVENTION

The present invention has been developed in view of the foregoing circumstances. It is an object of the present invention to provide an electron beam lithography method and an electron beam lithography apparatus for performing electron beam lithography, which are capable of forming more uniform patterns by improving the line width roughness of data group patterns and the fluctuations in bit sizes of data bit patterns, and also capable of drawing servo patterns with more highly accurate pattern arrangements.

It is another object of the present invention to provide a production method for molds, including imprinting molds having fine patterns which are drawn accurately by the electron beam lithography method. It is a further object of the present invention to provide a method for producing magnetic disk media, onto which patterns of protrusions and recesses are transferred using the molds.

An electron beam lithography method of the present invention comprises the steps of:

coating a base plate with resist;

placing the base plate on a rotating stage; and

irradiating an electron beam on the base plate to draw a fine pattern corresponding to a fine pattern of a high density magnetic recording medium, which is a discrete track medium, having servo patterns that extend in the width direction of tracks in servo areas and data groove patterns that extend in the circumferential direction of the tracks in data areas, or a bit patterned medium, having the servo patterns in servo areas and data bit patterns in data areas;

the irradiation timing of the electron beam being controlled by ON/OFF signals output to a blanking means for shielding electron beam irradiation;

the deflecting operations of the electron beam being controlled by deflecting signals output to a beam deflecting means;

the beam irradiation level of the electron beam and the linear velocity of the base plate being maintained constant at least during each rotation of the base plate, the servo patterns and the data groove pattern or the data bit patterns corresponding to a single track of the fine pattern being drawn on the entire surface of the base plate over a plurality of rotations of the base plate; and

the electron beam being scanned in two directions by the deflecting signals so as to fill the shapes of the servo patterns during a specific rotation, while the data groove pattern or the data bit patterns are drawn as a continuous line or a broken line with a single electron beam emission, and the data groove pattern or the data bit patterns not being drawn during other rotations, by the electron beam being shielded by the blanking means.

In the lithography method of the present invention, it is preferable for rotational control to be exerted such that the rotating speed of the rotating stage becomes faster at the inner tracks and slower at the outer tracks, inversely proportionate to the radii of drawing positions, thereby maintaining the linear velocity of the rotating base plate constant.

In the lithography method of the present invention, it is preferable for the servo patterns to be drawn by reciprocally modulating the electron beam in the radial direction of the base plate or a direction perpendicular to the radial direction of the base plate, and by deflecting the electron beam in directions perpendicular to the modulating direction so as to fill the shapes of the servo patterns.

In the lithography method of the present invention, the groove patterns may be drawn by continuously irradiating the electron beam onto the base plate, which is rotating in a single direction.

In the lithography method of the present invention, the data bit patterns may be drawn by intermittently irradiating the electron beam onto the base plate, which is rotating in a single direction.

An electron beam lithography apparatus of the present invention is that which realizes the electron beam lithography method of the present invention, and comprises:

a rotating stage, on which a base plate having resist coated thereon is placed and rotated;

a drive control section, for maintaining the rotating speed of the rotating stage according to the radii of drawing positions to maintain the linear velocity of the rotating base plate constant;

blanking means, for shielding irradiation of an electron beam emitted from an electron gun;

beam deflecting means, for deflecting the electron beam in a rotating direction and a radial direction to perform scanning; and

a formatter, for outputting ON/OFF signals to the blanking means and deflecting signals to the beam deflecting means, based on lithography data signals.

A method for producing a mold of the present invention comprises:

coating a base plate with resist;

drawing a desired fine pattern of protrusions and recesses by the electron beam lithography method of the present invention; and

exposing the resist. Here, the mold is a carrier having a desired pattern of protrusions and recesses on the surface thereof. Examples of such a mold include an imprinting mold for transferring the shapes of the pattern of protrusions and recesses to magnetic disk media.

A method for producing a magnetic disk medium of the present invention comprises:

coating a base plate with resist;

drawing a desired fine pattern of protrusions and recesses by an electron beam lithography method of the present invention;

exposing the resist, to obtain an imprinting mold; and transferring the fine pattern of protrusions and recesses onto the magnetic disk medium.

The electron beam lithography method of the present invention comprises the steps of: coating a base plate with resist; placing the base plate on a rotating stage; and irradiating an electron beam on the base plate to draw a fine pattern corresponding to a fine pattern of a high density magnetic recording medium, which is a discrete track medium, having servo patterns that extend in the width direction of tracks in servo areas and data groove patterns that extend in the circumferential direction of the tracks in data areas, or a bit patterned medium, having the servo patterns in servo areas and data bit patterns in data areas; the irradiation timing of the electron beam being controlled by ON/OFF signals output to a blanking means for shielding electron beam irradiation; the deflecting operations of the electron beam being controlled by deflecting signals output to a beam deflecting means; the beam irradiation level of the electron beam and the linear velocity of the base plate being maintained constant at least during each rotation of the base plate, the servo patterns and the data groove pattern or the data bit patterns corresponding to a single track of the fine pattern being drawn on the entire surface of the base plate over a plurality of rotations of the base plate; and the electron beam being scanned in two directions by the deflecting signals so as to fill the shapes of the servo patterns during a specific rotation, while the data groove pattern or the data bit patterns are drawn as a continuous line or a broken line with a single electron beam emission, and the data groove pattern or the data bit patterns not being drawn during other rotations, by the electron beam being shielded by the blanking means. Thereby, the servo patterns are drawn by two or more overlapping drawing operations over a plurality of rotations, to cancel out positional fluctuations during each rotation, the arrangement accuracy thereof is improved, resulting in increased pitch accuracy. Meanwhile, the data groove pattern or the data bit patterns are drawn as a continuous line or as a broken line during a single rotation with a single electron beam emission. Thereby, deterioration of LWR caused by drawing in spliced sections using the high speed modulating scan method (U.S. Patent Application Publication No. 20090123870) and deterioration of LWR caused by decreased latent image contrast due to a plurality of scanning operations using the multi pass method (U.S. Patent Application Publication No. 20050151284) can be avoided. LWR can be maintained at a minimum, highly fine pattern drawing becomes possible, and fine patterns according to designs can be drawn with high accuracy on the entire surface of the base plate.

That is, with respect to errors in the irradiation position of the electron beam (positional shifts) due to errors in rotational driving of the base plate during each rotation, timing errors in ON/OFF control of beam irradiation, etc., which are the factors that deteriorate the arrangement accuracy of servo patterns, the lithography method of the present invention draws the servo patterns by scanning the electron beam in two directions so as to fill the shapes of the servo patterns in an overlapped manner over a plurality of rotations. Thereby, the overlapped drawing averages out the errors compared to the high speed modulating scan method (disclosed in U.S. Patent Application Publication No. 20090123870) that performs drawing within a single rotation, to correct the positions to the proper positions. In addition, deterioration of the drawing accuracy due to errors in the irradiation position of the electron beam (positional shifts) and deterioration of pitch accuracy due to accumulated variations in the beam irradiation position can be improved compared to the multi path method (disclosed in U.S. Patent Application Publication No. 20050151284), which divides each track and performs drawing over a plurality of rotations. The improvements in the arrangement and the formation accuracy lead to improved tracking performance to position magnetic heads, and tracking performance corresponding to high recording density can be maintained.

In the lithography method of the present invention, the data groove pattern or the data bit patterns are drawn as a continuous line or as a broken line by a single electron beam emission. Thereby, the data group pattern or the data bit patterns have fewer protrusions and recesses in their shapes and more favorable LWR, compared to those formed by multiple exposure drawing or spliced drawing. Accordingly, the data recording properties to the data areas can be improved.

Particularly, advantageous effects, that the LWR is improved in the data group pattern and bit size fluctuations are reduced in data bit patterns, are obtained. That is, the electron beam is irradiated with a fixed irradiation position. Therefore, no influence is imparted by deflection accuracy, and the rotation of the base plate is stable. Accordingly, the steps and line width variations caused by the conventional scan method and the line width variations caused by overlapped drawing by the multi pass method are reduced, and accuracy can be improved with small LWR values. With respect to drawing of data bit patterns, the drawing intervals and the drawing times can be maintained constant accompanying the rotational linear velocity of the base plate and the ON/OFF accuracy of the blanking means being secured. Thereby, fluctuations in bit size can be reduced, and the data bit patterns can be formed at a constant bit size. Accordingly, phenomena, such as data groove patterns of adjacent tracks being connected, a single data groove pattern being cut off, the gaps among bits of data bit patterns becoming irregular and disrupting bit arrangements, can be prevented, and uniform pattern formation can be performed.

Rotational control may be exerted such that the rotating speed of the rotating stage becomes faster at the inner tracks and slower at the outer tracks, inversely proportionate to the radii of drawing positions, thereby maintaining the linear velocity of the rotating base plate constant. In this case, dose amounts can be equalized at the inner tracks and the outer tracks, and control corresponding to radial positions can be performed easily and with high accuracy.

The lithography method of the present invention, can be optimally applied in cases that the servo patterns are drawn by reciprocally modulating the electron beam in the radial direction of the base plate or a direction perpendicular to the radial direction of the base plate, and by deflecting the electron beam in directions perpendicular to the modulating direction so as to fill the shapes of the servo patterns.

In the lithography method of the present invention, the groove patterns may be drawn by continuously irradiating the electron beam onto the base plate, which is rotating in a single direction. In this case, control can be simplified.

Meanwhile, the electron beam lithography apparatus of the present invention is that which realizes the electron beam lithography method of the present invention, and comprises: a rotating stage, on which a base plate having resist coated thereon is placed and rotated; a drive control section, for maintaining the rotating speed of the rotating stage according to the radii of drawing positions to maintain the linear velocity of the rotating base plate constant; blanking means, for shielding irradiation of an electron beam emitted from an electron gun; beam deflecting means, for deflecting the electron beam in a rotating direction and a radial direction to perform scanning; and a formatter, for outputting ON/OFF signals to the blanking means and deflecting signals to the beam deflecting means, based on lithography data signals. Thereby, desired fine patterns can be drawn with high accuracy, and the time required for drawing can be shortened, by improvements in drawing efficiency.

The method for producing a mold of the present invention comprises: coating a base plate with resist; drawing a desired fine pattern of protrusions and recesses by the electron beam lithography method of the present invention; and exposing the resist. Thereby, a carrier having a highly accurate pattern of protrusions and recesses on the surface thereof can be easily obtained.

The method for producing a magnetic disk medium of the present invention comprises: coating a base plate with resist; drawing a desired fine pattern of protrusions and recesses by an electron beam lithography method of the present invention; exposing the resist, to obtain an imprinting mold; and transferring the fine pattern of protrusions and recesses onto the magnetic disk medium. The imprinting mold can be pressed against the surface of a resin layer which functions as a mask during the formation process of the magnetic disk medium. Thereby, the pattern of protrusions and recesses is transferred onto the surface of the medium at once, and magnetic disk medium, such as a discrete track medium or a bit patterned medium, having superior properties can be produced easily.

### BRIEF DESCRIPTION OF THE DRAWINGS

FIG. 1 is a plan view of an example of a fine pattern which is drawn on a base plate by an electron beam lithography method of the present invention.

FIG. 2 is a magnified view of a portion of a fine pattern for a discrete track medium.

FIG. 3 is a graph that illustrates the relationship between radial drawing positions and base plate rotating speed.

FIG. 4 is a diagram that illustrates the schematic configuration of an electron beam lithography apparatus for executing the electron beam lithography method of the present invention.

FIG. 5 is a collection of diagrams that illustrate drawing of elements that constitute a fine pattern of a discrete track medium during a first rotation by an example of a basic lithography method A, and various switching signals B through E for pattern shape deflecting signals and the like during the drawing of the elements.

FIG. 6 is a collection of diagrams that illustrate drawing of elements that constitute a fine pattern of a discrete track medium during a second rotation A, and various switching signals B through E for pattern shape deflecting signals and the like during the drawing of the elements.

FIG. 7 is a collection of diagrams that illustrate drawing of elements that constitute a fine pattern of a bit patterned medium during a first rotation by another example of a basic lithography method A, and various switching signals B through E for pattern shape deflecting signals and the like during the drawing of the elements.

FIG. 8 is a schematic sectional diagram that illustrates a process by which an imprinting mold equipped with a fine pattern drawn by the electron beam lithography method is employed to transfer the fine pattern onto a magnetic disk medium.

FIG. 9A is a diagram that illustrates a drawn fine pattern to explain lithography according to a conventional high speed modulating scan method.

FIG. 9B is a diagram that illustrates a drawn fine pattern to explain lithography according to a conventional multi pass scan method.

FIG. 9C is a diagram that illustrates a drawn fine pattern according to an embodiment of the present invention to explain lithography according to the electron beam lithography method of the present invention.

FIG. 10 is a collection of electron microscope photographs for comparing data groove patterns of a first comparative example drawn by the conventional high speed modulating scan method of FIG. 9A, data groove patterns of a second comparative example drawn by the conventional multi pass method of FIG. 9B, and data groove patterns of a first embodiment drawn by the electron beam lithography method of the present invention of FIG. 9C.

### DESCRIPTION OF THE PREFERRED EMBODIMENTS

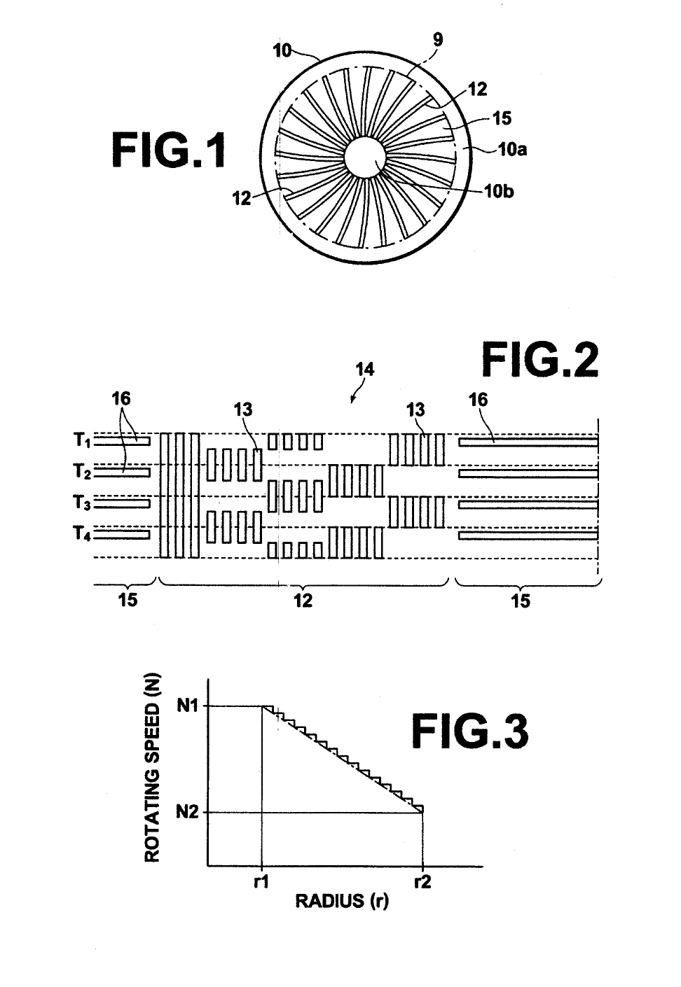

Hereinafter, an embodiment of the present invention will be described in detail with reference to the attached drawings. FIG. 1 is a plan view of an example of a fine pattern which is drawn on a base plate by an electron beam lithography method of the present invention. FIG. 2 is a magnified view of a portion of a fine pattern for a discrete track medium.

As illustrated in FIG. 1 and FIG. 2, a fine pattern 9 of protrusions and recesses for a magnetic disk medium is constituted by servo areas 12 and data regions 15, which are regularly and alternately provided in the circumferential direction. Servo patterns 14 are formed in the servo areas 12. The fine pattern 9 is formed within an annular region of a base plate 10, excluding the outer peripheral portion 10b and a central portion 10b. The servo patterns 14 are formed within thin servo areas 12 that extend substantially radially from the central portion at equidistant intervals through each sector of concentric tracks of the base plate 10. Commonly, servo areas 12 are formed as arcuate lines that extend in the radial direction, as illustrated in FIG. 1.

FIG. 2 is a magnified view of a portion of a hard disk pattern for a discrete track medium. Fine rectangular servo elements 13 that correspond to preamble, address, and burst signals are formed on concentric tracks T1 through T4 in the servo pattern 14 of FIG. 2. Each servo element has a width of a single track, and a length in the track direction greater than the irradiation beam diameter of an electron beam. A portion of the servo elements corresponding to burst signals are provided shifted half a track so as to straddle adjacent tracks.

In addition to the servo patterns 14 formed in the servo areas 12 as described above, concentric data groove patterns 16 that extend in the track direction are formed in the rotating direction (the circumferential direction) within the data area 15, to separate the adjacent tracks T1 through T4 with grooves.

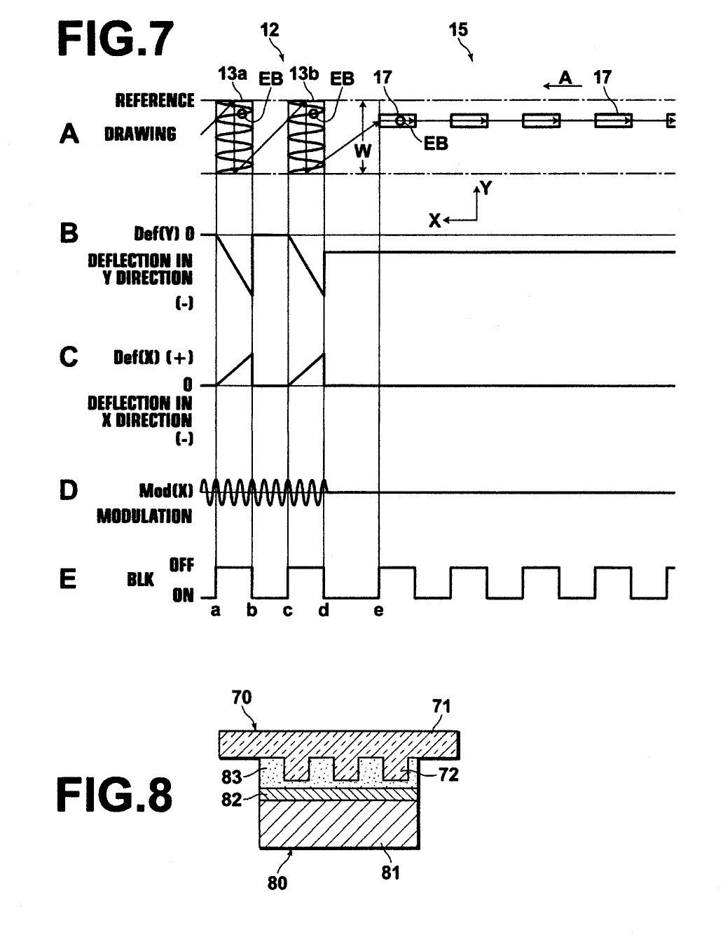

In addition, as illustrated schematically by an example of a hard disk pattern of a bit patterned medium in FIG. 7, data bit patterns 17 (dot patterns) are formed as broken lines within each track in the data area 15. The data bit patterns 17 are formed as concentric patterns at predetermined intervals that extend in the rotating direction (the circumferential direction).

Servo elements 13 corresponding to a single track are drawn during each rotation of the base plate 10. The servo elements 13 which are shifted half a track and straddle the adjacent tracks T1 through T4 are not divided in half, but are drawn during drawing of one of the tracks by shifting the drawing reference (beam irradiation deflecting reference) in the radial direction by half a track.

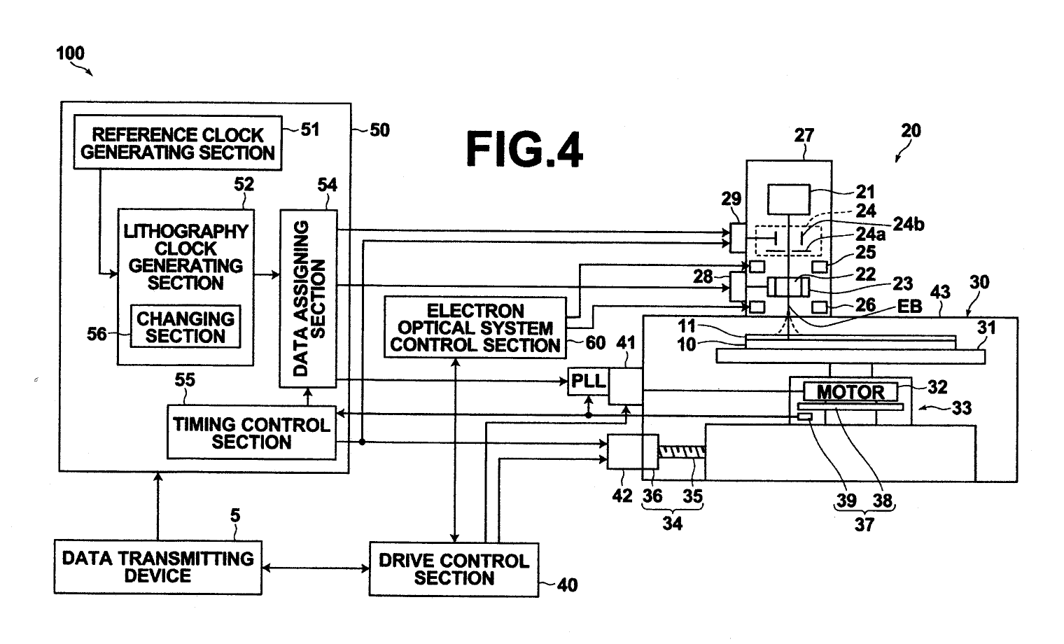

The servo elements 13 within the servo areas 12 and the data groove patterns 16 within the data areas 15 of the fine pattern 9 are drawn on the base plate 10, which is coated with resist 11. The base plate 10 is placed on a rotating stage 31 (refer to FIG. 4) and rotated, an electron beam EB scans the servo elements 13 and the data groove patterns 16 for each track sequentially from the inner tracks to the outer tracks or in the opposite direction, to irradiate and expose the resist 11.

FIG. 3 is a graph that illustrates the relationship between base plate rotating speeds N and the radius r at drawing positions at the inner tracks and the outer tracks of the base plate 10. The basic properties of the relationship denoted by the chain line indicate that rotation is controlled such that a rotating speed N2 at the outermost track (radius r2) is slower than a rotating speed N1 at the innermost track (radius r1), as a speed inversely proportionate to the radius. In actuality, the rotating speed N is not adjusted for each track. Instead, control is exerted to change the rotating speed N of the rotating stage 31 (refer to FIG. 4) linked with mechanical movement of the rotating stage 31 in the radial direction, after drawing a plurality of tracks (8 tracks, for example) that correspond to a deflectable range of the electron beam EB in the radial direction. The rotating speed N remains unchanged and the rotating stage 31 is driven to rotate at a constant speed at least during each rotation of the base plate 10.

In this manner, the rotating speed N of the rotating stage 31 is adjusted to be slow when drawing the outer tracks, and fast when drawing the inner tracks. Thereby, the base plate 10 is rotated at the same linear velocity at the outer circumferential portion and at the inner circumferential portion while the drawing position is moved in the radial direction, that is, moved across tracks within the drawing region of the fine pattern 9. This configuration is advantageous in that a uniform dose amount can be obtained for the electron beam EB during drawing, and that drawing position accuracy can be secured.

### <Electron Beam Lithography Apparatus>

An embodiment of an electron beam lithography apparatus for executing the electron beam lithography method of the present invention described above will be described. FIG. 4 is a diagram that illustrates the schematic structure of the electron beam lithography apparatus 100.

The electron beam lithography apparatus 100 is equipped with: an electron beam irradiating section 20, for irradiating an electron beam onto original plates; a drive section 30 for rotating and linearly moving the original plates; a drive control section 40, for exerting mechanical drive control on the drive section 30; a formatter 50, for generating lithography clock signals and for outputting operational timing signals for the electron beam irradiating section 20 and the drive section 30; an electron optical system control section 60, for exerting electron optical control on the electron beam emitted by the electron beam irradiating section 20; and a data transmitting device 5, for transmitting design data related to fine patterns 9 to be drawn to the formatter 50. Data is exchanged among the data transmitting device 5, the drive control section 40 and the electron optical system control section 60.

The electron beam irradiating section 20 is equipped with: an electron gun 21, for emitting the electron beam EB; deflecting means 22 and 23, for deflecting the electron beam EB in a radial direction Y and a direction X perpendicular to the radial direction (hereinafter, referred to as “rotating direction X” or “circumferential direction X”), and for reciprocally modulating the electron beam EB in the circumferential direction X at a predetermined amplitude; and an aperture 24b and a blank 24b (deflector) that function as a blanking means 24 for controlling the irradiation of the electron beam ED ON and OFF. A condensing lens 25 (electromagnetic lens) that varies the beam irradiation dosage by diaphragm adjustments is provided above the deflecting means 22 and 23. An objective lens 26 (electromagnetic lens) that varies the beam diameter of the electron beam EB is provided beneath the deflecting means 22 and 23.

By the construction described above, the electron beam EB is emitted from the electron gun 21, and the beam irradiation dosage and the beam diameter thereof is adjusted by the condensing lens 25. The electron beam EB is then irradiated onto/shielded from and deflected to scan the base plate 10, which is coated with the resist 11, in the XY directions by the deflecting means 22 and 23. During the scanning operation, the beam diameter of the electron beam EB is adjusted by the objective lens 26.

The electron beam irradiating section 20 and the drive section 30 to be described later are provided within a vacuum chamber, the interior of which is depressurized. The electron lithography apparatus 100 is configured such that the electron beam EB is irradiated onto the base plate 10 placed within the vacuum chamber, to perform pattern lithography.

The aperture 24a of the blanking means is equipped with a transparent aperture through which the electron beam EB passes at its center. The blank 24b allows the electron beam EB to pass through the transparent aperture of the aperture 24b without deflecting the electron beam EB when an OFF signal is input. On the other hand, when an ON signal is input, the blank 24b deflects the electron beam EB such that the electron beam does not pass through the transparent aperture of the aperture 24, and cuts the electron beam EB off at the aperture 24a such that it is not irradiated.

The drive section 30 is provided within a housing 43 having the lens tube 27 placed on the upper surface thereof. The drive section 30 is equipped with: a rotating stage unit 33 constituted by the rotating stage 31 for supporting original plates, and a spindle motor 32 having a motor shaft that matches the central axis of the stage 31; and a linear movement means 34, for moving the rotating stage unit 33 in a radial direction of the rotating stage 31. The linear movement means 34 is equipped with: a rod 35 having fine threads, which are in threaded engagement with a portion of the rotating stage unit 33; and a pulse motor 36, for driving the rod 35 to rotate in two rotational directions. An encoder 37 that outputs encoder signals corresponding to the rotational angle of the rotating stage 31 is provided in the rotating stage unit 33. The encoder 37 is equipped with: a rotating plate 38 having a plurality of radial slits therein, mounted on the motor shaft of the spindle motor 32; and an optical element 39 that optically reads the slits and outputs the encoder signals.

The drive control section 40 outputs drive control signals to a driver 41 for the spindle motor 32 and to a driver 42 for the pulse motor 36 of the drive section 30, to control the driving thereof.

The formatter 50 is equipped with: a reference clock signal generating section 51 that generates invariable reference clock signals; a lithography clock signal generating section 52 that generates lithography clock signals; a data assigning section 54 that outputs data signals based on the lithography clock signals to a PLL circuit, which is connected to a deflecting amplifier for the deflecting means 22 and 23, a blanking amplifier 29 for the blank 24b, and a driver 41 of the spindle motor 32; and a timing control section 55 that controls operational timings (data assignment timings) based on signals input from the encoder 37.

The lithography clock signal generating section 52 is equipped with a changing section 56 that changes the frequency of the lithography clock signals according to the radial position of the base plate 10. The number of lithography clock signals for drawing a single servo element 13 and a data groove pattern 16 is set to be the same at the inner and outer peripheries of the base plate 10.

The data transmitting device 5 stores lithography design data (data that represent lithography patterns and lithography timings) of fine patterns 9 to be drawn, such as hard disk patterns. The data transmitting device 5 transmits lithography design data signals to the drive control section 40, the formatter 50, and the electron optical system control section 60.

The electron optical system control section 60 outputs control signals to the condensing lens 25 and the objective lens 26, which are electromagnetic lenses in the electron beam irradiating section 20, to control the electron optical properties of these electromagnetic lenses.

In the electron beam lithography apparatus 100, the data transmitting device 5 outputs the lithography design data signals to the formatter 50. The formatter 50 assigns the lithography design data as control signals to control ON/OFF operations of the blanking means 24, to control X-Y deflecting operations of the electron beam EB by the deflecting means 22 and 23, to control the rotational speed of the rotating stage 31 and the like, and assigns the control signals to the respective amplifiers 28 and 29 and the drivers 41 and 42. The control signals are synchronized with encoder signals which are output by the encoder 37, and output at predetermined timings. The blanking means 24, the deflecting means 22 and 23, the spindle motor 36, and the pulse motor 36 are driven based on the signals output from the formatter 50, to draw desired fine patterns on the entirety of the surfaces of original plates.

The lithography design data signals are output from the data transmitting device 5 also to the electron optical system control section 60. Control signals (operating current values) for controlling the condensing lens 25 and the objective lens 26 are changed according to the type of pattern to be drawn from among the first through third patterns of protrusions and recesses, to adjust the beam irradiation dosage and the beam diameter of the electron beam EB. Thereby, lithography accuracy and lithography speed suited for the type of pattern are set. At the same time, the rotational speed controlled by the spindle motor 32 and the lithography feed speed in the radial direction controlled by the deflecting means 23 and the pulse motor 36 are changed. Note that the beam irradiation dosage and the beam diameter are maintained at initially set values at least until lithography on a single base plate 10 is completed. That is, beam irradiation is performed without changing these parameters during lithography.

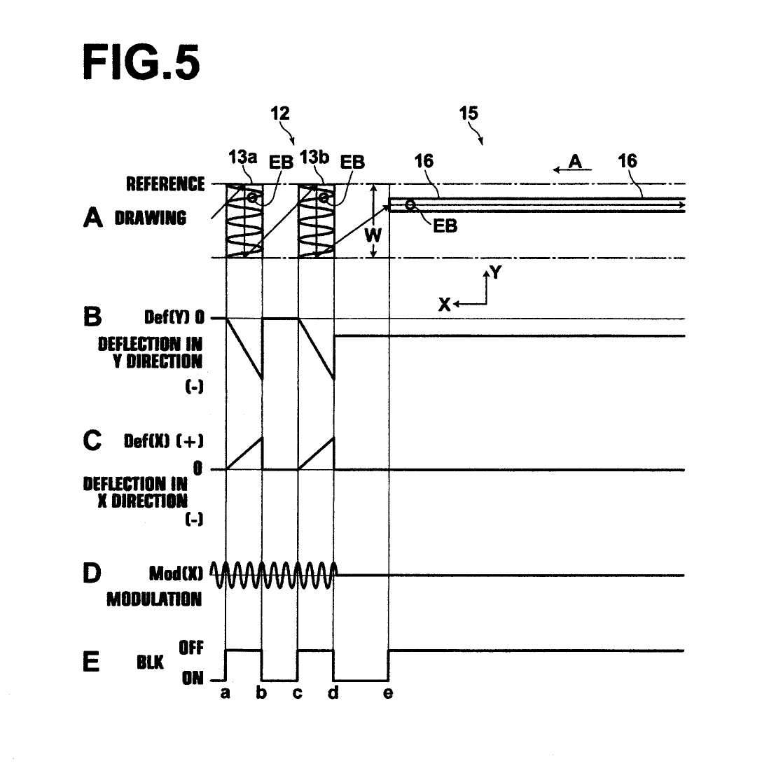

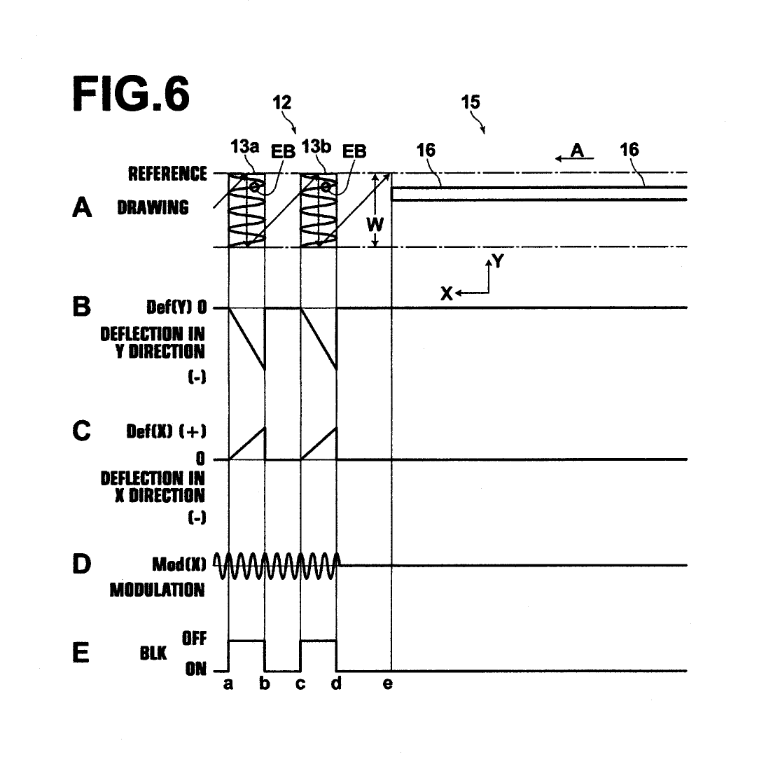

FIG. 5 and FIG. 6 are diagrams that illustrate an example of a drawing method according to the electron beam lithography method of the present invention, for the shapes of the servo elements 13 and the data group pattern 16 of a discrete track medium. In this example, patterns for s single track are drawn within two rotations. FIG. 5 illustrates the drawing which is performed during the first rotation, and FIG. 6 illustrates the drawing which is performed during the second rotation.

In addition, the two servo elements 13a and 13b illustrated in the figures are drawn by the high speed modulating scan method, to obtain a predetermined dose amount over two overlapped drawing operations. Meanwhile, the data groove pattern 16 is drawn in a single rotation, by continuous beam irradiation without blocking the beam. That is, the rotational linear velocity of the base plate 10 and the irradiation intensity of the electron beam EB (the beam irradiation level and the beam diameter) are set such that the data groove pattern 16 can be drawn and exposed at a predetermined line width by continuous irradiation during a single rotation. At these settings, the beam irradiation dosage during scanning of the servo elements 13a and 13b is half a prescribed dose amount, and the prescribed dose amount is obtained by the two overlapped drawing operations. In addition, in the case that the line widths of the data groove pattern 16 is even thinner, the dose amount for the servo elements 13a and 13b will be reduced, and three or more overlapped drawing operations will become necessary.

During a drawing operation performed in the first rotation illustrated in FIG. 5, the base plate (the rotating stage 31) is rotated in a single rotating direction A, the electron beam EB having a fine diameter is scanned in the circumferential direction X, which is perpendicular to the radial direction Y of the base plate 10, so as to continuously fill the shapes of the servo elements 13a and 13b at predetermined phase positions of a track T (having a track width W) that extends linearly from a microscopic viewpoint. Thereby, a first exposure and drawing operations of the servo elements 13a and 13b are performed.

The aforementioned scanning is performed by irradiating the electron beam EB, which has a beam diameter smaller than the minimum length of the servo elements 13a and 13b in the track direction, under ON/OFF operations of the blanking means 24 (the aperture 24a and the blank 24b) according to drawing positions. In addition, the electron beam EB is deflected in the radial direction Y and in the circumferential direction X perpendicular to the radial direction, to perform lithography in the Y direction within the track width W. Further, the electron beam EB is reciprocally modulated with a constant amplitude at high speed in the circumferential direction X perpendicular to the radial direction Y as indicated by A of FIG. 5, to perform exposure and drawing operations.

The data groove pattern 16 of the same track is drawn during the same rotation in which the first drawing operations of the servo elements 13a and 13b are performed. The electron beam EB is deflected in the radial direction Y to a radial drawing position of the data groove pattern 16 and irradiated while the position in the rotating direction X is fixed. Thereby, the data groove pattern 16 having a predetermined length determined by a beam scanning speed corresponding to the rotation speed (rotational linear velocity) and irradiation time (blanking OFF time) is drawn along the track direction accompanying the rotation of the base plate 10 by the rotating stage 31. At this time, the high speed reciprocal modulation of the electron beam EB in the circumferential direction X for drawing the servo elements 13 is ceased. Note that the reciprocal modulation may be that which is performed in the radial direction Y of the base plate 10.

A detailed description will be given with reference to FIG. 5. A of FIG. 5 is a diagram that illustrates the drawing operations of the electron bean EB in the radial direction Y and the circumferential direction X (rotating direction) of the base plate 10. B of FIG. 5 is a diagram that illustrates deflection signals Def(Y) for the electron beam EB in the radial direction Y. C of FIG. 5 is a diagram that illustrates deflection signals Def(X) for the electron beam EB in the circumferential direction X. D of FIG. 5 is a diagram that illustrates modulation signals Mod(X) for the electron beam EB in the circumferential direction X. E of FIG. 5 is a diagram that illustrates ON/OFF operations according to blanking signals BLK. Note that the horizontal axes of A through E of FIG. 5 denote rotational phases.

First, the base plate rotating speed N is set to a predetermined rotating speed corresponding to the radial drawing position according to the graph of FIG. 3. At point a, the blanking signal BLK is turned OFF, and the electron beam EB is irradiated to initiate drawing of the servo element 13a. The electron beam EB, which is at a reference position (drawing initiating position) is reciprocally modulated by the modulation signal Mod(X) indicated by D of FIG. 5, and deflected in the radial direction (-Y) by the deflection signal Def(Y) indicated by B of FIG. 5. At the same time, the electron beam EB is deflected in the circumferential direction X (in the same direction as direction A) by the deflection signal Def(X) indicated by C of FIG. 5, to compensate for shifts in the irradiation position thereof due to rotation of the base plate 10 in direction A. Thereby, the servo element 13a is scanned such that the rectangular shape thereof is filled. Irradiation of the electron beam EB is ceased at point b by the blanking signal BLK being turned ON, and drawing of the servo element 13a is completed. After point b, deflections in the radial direction Y and the circumferential direction X are returned to the reference position illustrated in A of FIG. 5.

Next, when the base plate 10 is rotated to point c, drawing of the next servo element 13b is initiated in a similar manner, the servo element 13b is drawn by similar deflection signals, and drawing of the servo element 13b is completed at point d. Note that the drawing lengths of the servo elements 13a and 13b in the circumferential direction X are defined by the amplitude of the reciprocal modulation of the electron beam EB according to the modulation signal Mod(X) as indicated in D of FIG. 5.

Thereafter, the deflection signal Def(Y) is set to the radius of the drawing position of the data groove pattern 16 as indicated by B of FIG. 5. When the base plate 10 is rotated to point e, the blanking signal BLK is turned OFF to irradiate the electron beam ED, and drawing of the data groove pattern 16 within the data area 15 is initiated.

In this case, the modulation signal Mod(X) is turned OFF as indicated in D of FIG. 5, to cease modulation of the electron beam EB in the circumferential direction X. In addition, the deflection signal Def(X) is also turned OFF to perform irradiation while the electron beam EB is fixed in the X direction. Thereby, the data groove pattern 16 is drawn as an arcuate line along the track. The blanking signal BLK is turned ON after the data groove pattern 16 is drawn for a predetermined length, to cease irradiation of the electron beam EB.

During a drawing operation performed in the second rotation illustrated in FIG. 6, the base plate (the rotating stage 31) is rotated in a single rotating direction A. The electron beam EB is scanned so as to continuously fill the shapes of the servo elements 13a and 13b of the same track as those drawn in the first rotation of FIG. 5, controlled in the same manner. Meanwhile, the data groove pattern 16 of the track is not drawn, by the electron beam EB being blocked by the blanking signal BLK being turned ON.

A detailed description will be given with reference to FIG. 6. Figure is a collection of diagrams that correspond to the collection of diagrams of FIG. 5, and illustrate drawing operations and control signals. When the base plate 10 is rotated to point a, the blanking signal BLK is turned OFF, and the electron beam EB is irradiated to initiate drawing of the servo element 13a. The electron beam EB is scanned to fill the rectangular shape of the servo element 13a by the modulation signal Mod(X) as indicated in D, the deflection signal Def(Y) as indicated in B, and the deflection signal Def(X) as indicated in C of FIG. 6 in the same manner as in the example of FIG. 5. Irradiation of the electron beam EB is ceased at point b by the blanking signal BLK being turned ON, and drawing of the servo element 13a is completed. Next, when the base plate 10 is rotated to point c, drawing of the next servo element 13b is initiated in a similar manner, the servo element 13b is drawn by similar deflection signals, and drawing of the servo element 13b is completed at point d. Thereafter, the deflections of the electron beam EB in the radial direction Y and the circumferential direction X are returned to the reference position illustrated in A of FIG. 6.

When the base plate 10 is further rotated to point e, where drawing of the data groove pattern 16 was initiated during the first rotation, the blanking signal BLK remains ON as indicated in E of FIG. 6, to block irradiation of the electron beam EB, and the data groove pattern 16 is not drawn during the second rotation.

After a the servo elements and the data groove pattern for a single track are drawn on the base plate 10 by the two rotations illustrated in FIG. 5 and FIG. 6, the irradiation position of the electron beam EB is deflected one track in the radial direction Y, to move to a next track. Servo elements and a data groove pattern are drawn over two rotations for the next track in a similar manner. This process is repeated until servo areas 12 and data areas 15 of a desired fine pattern 9 are drawn across the entire region of the base plate 10. The movement of the electron beam EB among tracks is performed by linear movement of the rotating stage 31. The linear movement may be performed after each track is drawn, or after a plurality of tracks (8 tracks, for example) are drawn, according to the deflectable range of the electron beam EB in the radial direction Y.

Note that the drawing width (practical exposure width) of the electron beam EB becomes wider than the beam diameter depending on amounts of irradiation time. Therefore, in order to perform drawing at the element widths, the relative linear velocity and scanning speed during drawing of the servo elements 13 and the groove elements 16 are set to define irradiation dosages, to perform scanning at predetermined irradiation dosages to achieve the ultimate drawing widths for the elements.

FIG. 7 is a collection of diagrams that illustrate an example of a drawing method according to the electron beam lithography method of the present invention, for the shapes of the servo elements 13 and the data bit patterns 17 of a bit patterned medium. In this example, patterns for s single track are drawn within two rotations. FIG. 7 illustrates the drawing which is performed during the first rotation. The drawing which is performed during the second rotation is the same as that described above with reference to FIG. 6, and therefore, drawings and descriptions thereof will be omitted.

The fine pattern of the bit patterned media include the servo elements 13 that extend in the track width direction within the servo areas 12 and the data bit patterns 17 that extend in the circumferential direction of the track as a broken line within the data areas 15. The servo elements 13a and 13b are drawn in the same manner as the servo elements 13a and 13b illustrated in A of FIG. 5. The data bit patterns 17 are drawn by intermittently irradiating the electron beam EB by repeated ON and OFF operations of the blanking signal BLK instead of the continuous irradiation when drawing the data groove pattern 16 illustrated in A of FIG. 5.

A detailed description will be given with reference to FIG. 7. FIG. 7 is a collection of diagrams that correspond to the collection of diagrams of FIG. 5, and illustrate drawing operations and control signals. When the base plate 10 is rotated to point a, the blanking signal BLK is turned OFF as indicated by E of FIG. 7, and the electron beam EB is irradiated to initiate drawing of the servo element 13a. The electron beam EB is scanned to fill the rectangular shape of the servo element 13a by the modulation signal Mod(X) indicated in D, the deflection signal Def(Y) indicated in B, and the deflection signal Def(X) indicated in C of FIG. 7 in the same manner as in the example of FIG. 5. Irradiation of the electron beam EB is ceased at point b by the blanking signal BLK being turned ON, and drawing of the servo element 13a is completed.

Next, when the base plate 10 is rotated to point c, drawing of the next servo element 13b is initiated in a similar manner, the servo element 13b is drawn by similar deflection signals, and drawing of the servo element 13b is completed at point d.

Thereafter, the deflection signal Def(Y) is set to the radius of the drawing position of the data bit patterns 17 as illustrated in B of FIG. 7. When the base plate 10 is rotated to point e, the blanking signal BLK is turned OFF to irradiate the electron beam EB, and drawing of the data bit patterns 17 within the data area 15 is initiated.

In this case, the modulation signal Mod(X) is turned OFF as indicated in D of FIG. 7, to cease modulation of the electron beam EB in the circumferential direction X. In addition, the deflection signal Def(X) is also turned OFF to perform irradiation while the electron beam EB is fixed in the X direction. The blanking signal BLK is turned ON and OFF at predetermined periods, as illustrated in E of FIG. 7. The data bit patterns 17 are drawn while the blanking signal BLK is OFF, and intervals among the data bit patterns 17 are set while the blanking signal is ON. Thereby, the data bit patterns 17 are drawn as a dot pattern along an arcuate line along the track. The blanking signal BLK is turned ON after the data bit patterns 17 are drawn for a predetermined length, to cease irradiation of the electron beam EB.

Note that the fine pattern of the bit patterned medium illustrated in A of FIG. 7 is merely an example. Fine patterns of bit patterned media may be in various other formats, each having bit sizes corresponding to the format. The settings for the drawing method are changed according to the various bit sizes.

Next, FIG. 8 is a schematic sectional view that illustrates a process by which an imprinting mold 70, having a fine pattern drawn by the electron beam lithography apparatus 100 using the electron beam lithography method described above, is employed to transfer a fine pattern of protrusions and recesses to a magnetic disk medium.

The imprinting mold 70 is constituted by: a base plate 71 formed by a light transmissive material; and resist 11 (not shown) coated on the surface of the base plate 71. Servo patterns 14 are drawn on the resist. Thereafter, a developing process is administered, to form a resist pattern of protrusions and recesses on the base plate 71. The base plate 71 is etched using the patterned resist as a mask, then the resist is removed, to obtain the imprinting mold 70, which has a fine pattern of protrusions and recesses 72 formed on the surface thereof. An example of the fine pattern of protrusions and recesses 72 is that which is equipped with servo patterns and data groove patterns for discrete track media.

The imprinting mold 70 is employed to produce magnetic disk medium 80 by the imprinting method. The recording medium 80 is equipped with a substrate 81, a magnetic layer 82, and a resin resist layer 83 for forming a mask layer on the magnetic layer 82. The fine pattern of protrusions and recesses 72 of the imprinting mold 70 is pressed against the resin resist layer 83, then ultraviolet rays are irradiated to cure the resin resist layer 83, to transfer the shapes of the protrusions and recesses of the fine pattern 72. Thereafter, the magnetic layer 82 is etched based on the shapes of the protrusions and recesses of the resin resist layer 83, to produce the magnetic disk medium 80 which has the magnetic layer 82 with a fine pattern of protrusions and recesses.

The method for producing the imprinting mold using the electron beam lithography method of the present invention described above is merely an example. The present invention is not limited to the production method described above, as long as a step, in which patterns of protrusions and recesses are formed by drawing fine patterns using the electron beam lithography method of the present invention, is included.

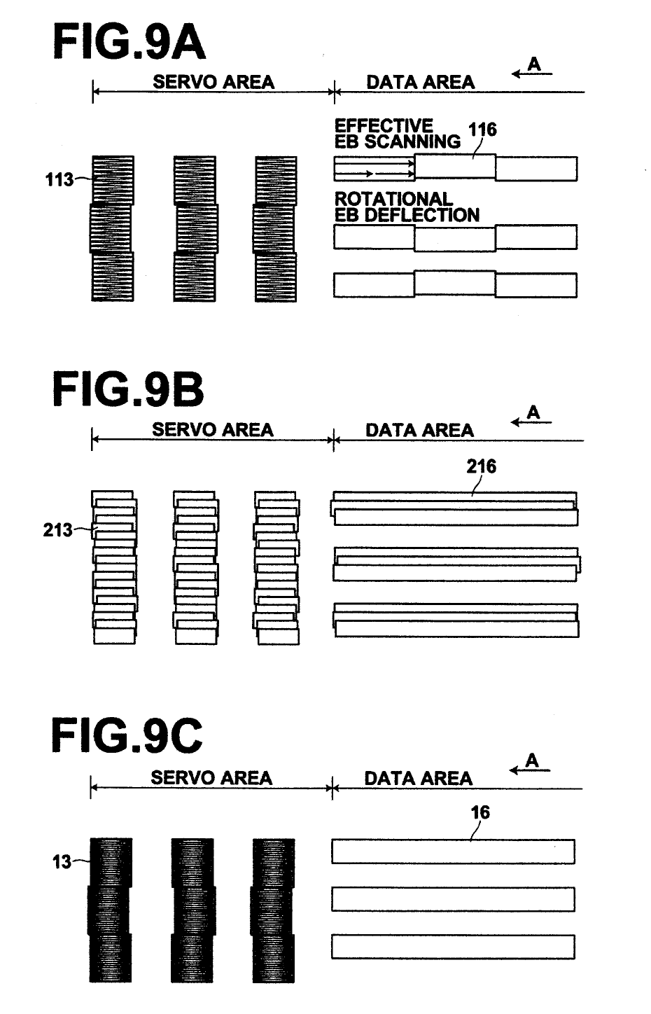

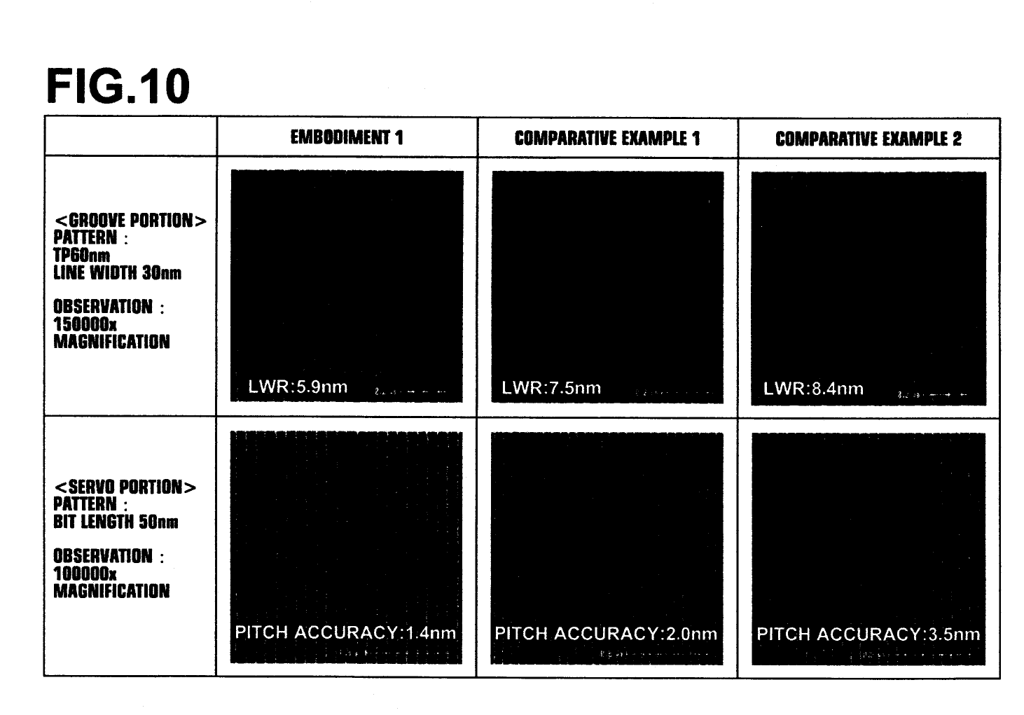

The results of observing the drawn shapes of a data groove pattern 116 of a first comparative example drawn by the aforementioned high speed modulating scan method illustrated in FIG. 9A, a data groove pattern 216 of a second comparative example drawn by the aforementioned multi pass method illustrated in FIG. 9B, and a DTM pattern of a first embodiment drawn by the lithography method of the present invention illustrated in FIG. 9C with a CD-SEM (Critical Dimension Scanning Electron Microscope) are illustrated in Table 1 and FIG. 10. The drawing conditions for the first embodiment, the first comparative example, and the second comparative example were as follows.

### Embodiment 1

The electron beam lithography method of the present invention was employed to draw each track over two rotations as illustrated in FIG. 9C, based on the drawing method of FIG. 5 and FIG. 6. That is, the servo elements 13 were drawn by two overlapping drawing operations, and each data groove pattern 16 was drawn by a single electron beam emission.

A DTM pattern having a track pitch of 60nm, a groove line width of 30 nm (corresponding to half a track width), and a bit length of 50 nm, corresponding to a next generation HD800Gbpsi standard was employed as the evaluation pattern. The experiment was using an electron beam lithography apparatus such as that illustrated in FIG. 4 equipped with a rotating stage with an acceleration voltage of 50 kV. A positive type electron beam resist was coated on a Si base plate and exposed. Note that the resist was processed under the following conditions: a prebake temperature of 120° C.; a post exposure bake temperature of 110° C.; and developed by the puddle development process with TMAH 2.38% for 60 seconds.

### COMPARATIVE EXAMPLE 1

The conventional high speed modulating scan method was employed to draw each track within a single rotation, as illustrated in FIG. 9A. That is, each servo element 113 was drawn by a single scanning operation, and each data groove pattern 116 was drawn in splices by intermittent irradiation, while deflecting the electron beam opposite the rotating direction. The shape of the evaluation pattern was the same as that for Embodiment 1. The rotating speed of the base plate was set to half that employed when the pattern of Embodiment 1, such that drawing of the servo elements 113 is performed with a predetermined dose amount with a single scanning exposure operation.

### COMPARATIVE EXAMPLE 2

The conventional multi pass method was employed to draw each track over 6 rotations, by dividing each track into 6 parts as illustrated in FIG. 9B. That is, servo elements 213 were drawn in an overlapped manner by ON/OFF control exerted over six deflections in the radial direction, and data groove patterns 216 were drawn in an overlapped manner over three rotations, while beam irradiation was blocked during the remaining three rotations.

### [Evaluation Method]

Differences in the quality of DTM patterns formed by the aforementioned lithography methods are illustrated in Table 1 and FIG. 10. The results of Table 1 were obtained by evaluating the LWR values of data groove patterns (groove portions) and the pitch accuracies of servo elements (servo portions) using the CD-SEM.

200 of the formed lines were measured, by setting the lengths of inspection regions (the length of the line inspection regions in the vertical direction) to 1 μm, and the intervals between inspection points (intervals between detected edges of inspected lines) to 2.5 nm, to calculate the LWR values and the pitch accuracies. The LWR values were obtained by measuring line widths, and by calculating a value 3a, which is three times the standard deviation σ of all measured data. The pitch accuracies were obtained by measuring the periodic intervals among lines, and by calculating a value 3σ, which is three times the standard deviation σ of all measured data.

TABLE 1

| | Groove Portion | Servo Portion |
|---|---|---|
| Lithography Method | LWR Value | Pitch Accuracy |
| Embodiment 1 | 5.9 nm | 1.4 nm |
| Comparative Example 1 | 7.5 nm | 2.0 nm |
| Comparative Example 2 | 8.4 nm | 3.5 nm |

From the results of Table 1, it can be understood that Embodiment 1 of the present invention exhibits significant improvements in the LWR value of the groove portions and the pitch accuracy of the servo portions, compared against Comparative Example 1 and Comparative Example 2.

As can be seen in the SEM photographs of FIG. 10, increased LWR, and faults such as discontinuous lines and pattern breakage at extremely thin lines accompanying the increased LWR can be observed in the data groove portion of Comparative Example 1. In addition, increased LWR, and faults such as discontinuous lines and pattern breakage at extremely thin lines accompanying the increased LWR can be observed in the data groove portion of Comparative Example 2. In contrast, LWR is maintained at a minimum in Embodiment 1, faults such as discontinuous lines and pattern breakage are not observed, and it was confirmed that favorable pattern formation was realized. With respect to the servo portions, in addition to being observable in the SEM photographs, it was confirmed that the pitch accuracy of Embodiment 1 is improved compared to those of Comparative Example 1 and Comparative Example 2.

What is claimed is:

1. An electron beam lithography method, comprising the steps of:
coating a base plate with resist;
placing the base plate on a rotating stage; and
irradiating an electron beam on the base plate to draw a fine pattern corresponding to a fine pattern of a high density magnetic recording medium, which is one of a discrete track medium, having servo patterns that extend in the width direction of tracks in servo areas and data groove patterns that extend in the circumferential direction of the tracks in data areas, and a bit patterned medium, having the servo patterns in servo areas and data bit patterns in data areas;
the irradiation timing of the electron beam being controlled by ON/OFF signals output to a blanking means for shielding electron beam irradiation;
the deflecting operations of the electron beam being controlled by deflecting signals output to a beam deflecting means;
the beam irradiation level of the electron beam and the linear velocity of the base plate being maintained constant at least during each rotation of the base plate, the servo patterns and one of the data groove pattern and the data bit patterns corresponding to a single track of the fine pattern being drawn on the entire surface of the base plate over a plurality of rotations of the base plate; and
the electron beam being scanned in two directions by the deflecting signals so as to fill the shapes of the servo patterns during a specific rotation, while one of the data groove pattern and the data bit patterns is drawn as one of a continuous line and a broken line with a single electron beam emission, and one of the data groove pattern and the data bit patterns not being drawn during other rotations by the electron beam being shielded by the blanking means, while the shapes of the servo patterns are drawn in an overlapping manner by repeating the scanning in the same manner as the first rotation.

2. An electron beam lithography method as defined in claim 1, wherein:
rotational control is exerted such that the rotating speed of the rotating stage becomes faster at the inner tracks and slower at the outer tracks, inversely proportionate to the radii of drawing positions, thereby maintaining the linear velocity of the rotating base plate constant.

3. An electron beam lithography method as defined in claim 1, wherein:
the servo patterns are drawn by reciprocally modulating the electron beam in one of the radial direction of the base plate and a direction perpendicular to the radial direction of the base plate, and by deflecting the electron beam in directions perpendicular to the modulating direction so as to fill the shapes of the servo patterns.

4. An electron beam lithography method as defined in claim 1, wherein:
the groove patterns are drawn by continuously irradiating the electron beam onto the base plate, which is rotating in a single direction.

5. An electron beam lithography method as defined in claim 1, wherein:
the bit patterns are drawn by intermittently irradiating the electron beam onto the base plate, which is rotating in a single direction.

6. An electron beam lithography apparatus, comprising:
a rotating stage, on which a base plate having resist coated thereon is placed and rotated;
a drive control section, for maintaining the rotating speed of the rotating stage according to the radii of drawing positions to maintain the linear velocity of the rotating base plate constant;
blanking means, for shielding irradiation of an electron beam emitted from an electron gun;
beam deflecting means, for deflecting the electron beam in a rotating direction and a radial direction to perform scanning; and
a formatter, for outputting ON/OFF signals to the blanking means and deflecting signals to the beam deflecting means, based on lithography data signals;
the formatter being equipped with a timing control section, for controlling the irradiation timing of the electron beam by outputting the ON/OFF signals to the blanking means, and for controlling the deflecting operations of the electron beam by outputting the deflecting signals to the electron beam deflecting means, when the electron beam is irradiated onto the base plate while rotating the rotating stage, to draw a fine pattern of a high density magnetic recording medium, which is one of a discrete track medium, having servo patterns that extend in the width direction of tracks in servo areas and data groove patterns that extend in the circumferential direction of the tracks in data areas, and a bit patterned medium, having the servo patterns in servo areas and data bit patterns in data areas;
the timing control section exerting the control such that the beam irradiation level of the electron beam and the linear velocity of the base plate are maintained constant at least during each rotation of the base plate, the servo patterns and one of the data groove pattern and the data bit patterns corresponding to a single track of the fine pattern are drawn on the entire surface of the base plate over a plurality of rotations of the base plate, and such that the electron beam is scanned in two directions by the deflecting signals so as to fill the shapes of the servo patterns during a specific rotation, while one of the data groove pattern and the data bit patterns is drawn as one of a continuous line and a broken line with a single electron beam emission, and one of the data groove pattern and the data bit patterns are not drawn during other rotations by shielding the electron beam by the blanking means, while the shapes of the servo patterns are drawn in an overlapping manner by repeating the scanning in the same manner as the first rotation.

7. A method for producing a mold, comprising:
coating a base plate with resist;
drawing a desired fine pattern of protrusions and recesses by an electron beam lithography method according to claim 1; and
exposing the resist.

8. A method for producing a magnetic disk medium, comprising:
coating a base plate with resist;
drawing a desired fine pattern of protrusions and recesses by an electron beam lithography method according to claim 1;
exposing the resist, to obtain an imprinting mold; and transferring the fine pattern of protrusions and recesses onto the magnetic disk medium.
